(19) United States
(12) Patent Application Publication
(10) Pub. No.: US 2026/0229043 A1
(43) Pub. Date: Aug. 6, 2026

(54) SENSOR FUSION BY COMBINING MULTIPLE PARAMETRIC PROJECTION SURFACES

(71) Applicant: QUALCOMM Incorporated, San Diego, CA (US)

(72) Inventors: Thorbjoern Sven Jemander, LINKÖPING (SE); Jonas Hammarstroem, LINKÖPING (SE)

(21) Appl. No.: 19/045,353

(22) Filed: Feb. 4, 2025

(51) Int. Cl. G06V 20/58; B60W 60/00; G06T 3/40; G06V 10/44; G06V 20/56

(52) U.S. Cl. CPC G06V 20/582; B60W 60/001; G06T 3/40; G06V 10/44; G06V 20/584; G06V 20/588; G06V 2201/07

(57) ABSTRACT

A method comprising: obtaining sensor data, wherein the sensor data includes representations of objects detected by sensors, the objects comprising one or more first detected objects and one or more second detected objects that are at distances less than and greater than a designated distance; generating a Bird's Eye View (BEV) feature tensor that represents the one or more first detected objects projected onto a BEV surface; generating a Generalized Perspective View (GPV) feature tensor that represents at least the one or more second detected objects projected onto a GPV surface; concatenating the BEV feature tensor and the GPV feature tensor along the sector lines of the BEV grid and the column lines of the GPV grid to generate a concatenated tensor; and perform a perception task based on the concatenated tensor.

### TECHNICAL FIELD

This disclosure relates to systems for image processing.

### BACKGROUND

Autonomous navigation and advanced driver-assistance systems (ADAS) are increasingly important features of vehicles. In general, these technologies involve generating a model of the environment of the vehicle based on map data and based on sensor data generated by sensors positioned on the vehicle. These sensors, which may include cameras, radars, and LIDARs, provide diverse types of data that need to be integrated effectively to ensure accurate perception and navigation. Traditional methods often involve projecting sensor data onto a Bird's Eye View (BEV) grid, which maps the vicinity of the vehicle.

### SUMMARY

In general, this disclosure describes techniques for processing sensor data. In the field of autonomous vehicles and advanced driver-assistance systems (ADAS), sensor fusion includes combining data from multiple sensors to create a comprehensive understanding of the vehicle's surroundings. Traditional methods of sensor fusion often involve projecting sensor data onto a Bird's Eye View (BEV) grid, which maps the vicinity of the vehicle. While BEV grids can be robust and provide good performance, BEV grids face significant limitations, particularly in terms of computational efficiency and scalability. The computational cost for maintaining a BEV grid increases disproportionately with the detection distance, making BEV grids impractical for long-range detection. Additionally, BEV grids can only represent information within their extent, leading to data loss beyond the grid's perimeter. This limitation is exacerbated by the z-collapsed representation used in BEV grids, which makes it difficult to encode information about elements that are perpendicular to the horizontal plane, such as traffic signs and overhead structures.

The techniques of this disclosure address these challenges by combining multiple parametric projection surfaces for sensor fusion. The method involves obtaining sensor data from multiple sensors, generating a BEV feature tensor for detections within a designated distance, and generating a Generalized Perspective View (GPV) feature tensor for detections beyond that distance. The BEV grid and GPV surface grid are aligned, and the tensors are concatenated to form a comprehensive representation. This approach may allow for efficient detection at both short and long ranges, leveraging the strengths of both BEV and GPV representations while minimizing computational costs.

In one example, this disclosure describes a method of

In another example, this disclosure describes a method

The details of one or more examples are set forth in the accompanying drawings and the description below. Other features, objects, and advantages will be apparent from the description, drawings, and claims.

### BRIEF DESCRIPTION OF DRAWINGS

FIG. 1 shows an example vehicle that may be configured to perform sensor fusion in accordance with one or more techniques of this disclosure.

FIG. 2 is a block diagram illustrating an example system that includes a plurality of sensors, a processing system, and one or more output devices, in accordance with one or more techniques of this disclosure.

FIG. 3 is a conceptual diagram illustrating projection perspective views of sensors of a vehicle onto a bird's eye view (BEV) surface.

FIG. 4A is a conceptual diagram illustrating dimensions of a BEV grid.

FIG. 4B is a conceptual diagram illustrating projection of objects detected by a set of sensors into a single position in a BEV grid.

FIG. 5 is a conceptual diagram illustrating an example perspective view surface of a single camera.

FIG. 6 is a conceptual diagram illustrating an example generalized perspective view (GPV) surface.

FIG. 7A and FIG. 7B are conceptual diagrams illustrating a top view of a vehicle with sensors that are not positioned at an origin point of a GPV surface.

FIG. 8A and FIG. 8B are conceptual diagrams illustrating a GPV surface and ghosting problems may occur in the elevation direction.

FIG. 9A and FIG. 9B are conceptual diagrams illustrating that distances between ghost objects vary based on distance from the origin of a GPV surface.

FIG. 10 is a conceptual diagram illustrating an example feature fusion surface, in accordance with one or more techniques of this disclosure.

FIG. 11 is a conceptual diagram illustrating that a largest parallax occurs when an origin-sensor axis is perpendicular to a viewing angle of an object.

FIG. 12 is a conceptual diagram illustrating a BEV cost function, a PV cost function, and a sum cost function.

FIG. 13A is a conceptual diagram illustrating an example height of a GPV surface, in accordance with one or more techniques of this disclosure.

FIG. 13B is a conceptual diagram illustrating an example height relative to a vehicle, in accordance with one or more techniques of this disclosure.

FIG. 13C is a conceptual diagram illustrating an example left and right yaw limit in accordance with one or more techniques of this disclosure.

FIG. 14 is a flowchart illustrating an example operation of a fusion system, in accordance with one or more techniques of this disclosure.

FIG. 15 is a conceptual diagram illustrating an example software architecture of the fusion system, in accordance with one or more techniques of this disclosure.

FIG. 16 is a flowchart illustrating an example operation of a fusion system for generating an initial BEV feature tensor and an initial GPV feature tensor, in accordance with one or more techniques of this disclosure.

FIG. 17 is a conceptual diagram illustrating an example of cropping and padding sensor data, in accordance with one or more techniques of this disclosure.

FIG. 18 is a conceptual diagram illustrating an example fusion space compute representation, in accordance with one or more techniques of this disclosure.

FIG. 19 is a conceptual diagram illustrating examples of sensor projection, in accordance with one or more techniques of this disclosure.

FIG. 20A is a conceptual diagram illustrating an example fusion grid with a truck partially within a BEV grid.

FIG. 20B and FIG. 20C are conceptual diagrams showing the truck in a BEV grid and a GPV grid, respectively.

FIG. 21A is a conceptual diagram illustrating an example fusion surface with a BEV surface and a partial GPV surface, in accordance with one or more techniques of this disclosure.

FIG. 21B is a conceptual diagram illustrating an example fusion grid with a partial BEV surface and a GPV surface, in accordance with one or more techniques of this disclosure.

FIG. 22 is a conceptual diagram illustrating an example fusion surface with a BEV surface and multiple GPV surface grids, in accordance with one or more techniques of this disclosure.

### DETAILED DESCRIPTION

In the field of autonomous vehicles and advanced driver-assistance systems (ADAS), sensor fusion includes combining data from multiple sensors to create a comprehensive understanding of a vehicle's surroundings. These sensors may include cameras, radars, and LIDARs. Traditional methods often involve projecting sensor data onto a Bird's Eye View (BEV) grid, which maps the vicinity of the vehicle. While BEV grids can be robust and have good performance, BEV grids face significant limitations, particularly in terms of computational efficiency and scalability. The computational cost for maintaining a BEV grid increases nonlinearly with the detection distance, making BEV grids impractical for long-range detection.

Accordingly, there is a need for more efficient methods that can extend detection capabilities without merely expanding the BEV grid, thereby conserving computational resources while maintaining high detection performance. The techniques described in this disclosure combine multiple parametric projection surfaces, such as BEV and Generalized Perspective View (GPV) grids, to enhance sensor fusion for both short and long-range detections, providing a robust and scalable solution for autonomous driving applications and other applications.

For instance, a computing system may obtain sensor data from a plurality of sensors. The sensor data may include representations of objects detected by the sensors. The objects may comprise one or more first detected objects that are at distances less than a designated distance and second detected objects that are at distances greater than the designated distance. The computing system may generate a Bird's Eye View (BEV) feature tensor that represents the one or more first detected objects projected onto a BEV surface. Additionally, the computing system may generate a Generalized Perspective View (GPV) feature tensor that represents the one or more second detected objects projected onto a GPV surface. A BEV grid of the BEV surface and a GPV grid of the GPV surface are defined such that sector lines of the BEV grid and column lines of the GPV grid are aligned. The computing system may concatenate the BEV feature tensor and the GPV feature tensor along the sector lines of the BEV grid and the column lines of the GPV surface grid to generate a concatenated tensor. The computing system may perform one or more perception tasks based on the concatenated tensor.

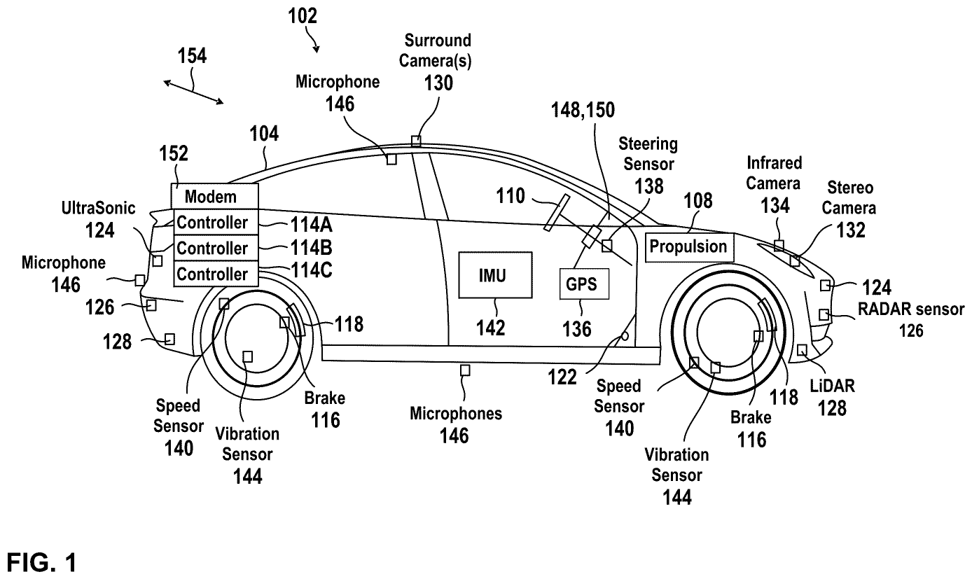

FIG. 1 shows an example vehicle 102 that may be configured to perform sensor fusion in accordance with one or more techniques of this disclosure. Vehicle 102 may comprise a passenger vehicle such as a car, truck, bus, train, and another type of vehicles that can accommodate a human driver and/or passengers. In some examples, vehicle 102 may comprise an autonomous vehicle or semi-autonomous vehicle. In this disclosure, references to vehicles may also apply with respect to robots and other types of machines or apparatuses that may or may not carry a driver or passengers.

Vehicle 102 may include an ADAS. Vehicle 102 may include a vehicle body 104 coupled to a chassis. In the example of FIG. 1, the chassis comprises four wheels and associated axles. In other examples, vehicles may include may had different quantities of wheels and axles. Vehicle 102 includes a propulsion system 108, such as an internal combustion engine, hybrid electric power plant, all-electric engine, or another type of machine for providing motive power to drive some or all of the wheels via a drive train. The drive train may include a transmission (not shown). A steering wheel 110 may be used to steer some or all of the wheels to direct vehicle 102 along a desired path when propulsion system 108 is operating and engaged to propel the vehicle 102. Steering wheel 110 or the like may be optional for Level 5 autonomous navigation implementations. One or more controllers 114A-114C (controllers 114) may provide autonomous capabilities in response to signals continuously provided in real-time from an array of sensors, as described more fully below.

One or more of controllers 114 may include one or more onboard computers that may be configured to perform deep learning and/or artificial intelligence functionality and output autonomous operation commands to self-drive vehicle 102 and/or assist the human vehicle driver in driving. Vehicles may have any number of distinct controllers for functional safety and additional features. For example, controller 114A may serve as the primary computer for autonomous driving functions, controller 114B may serve as a secondary computer for functional safety functions, and controller 114C may provide artificial intelligence functionality for in-camera sensors. In some examples, other controllers may provide infotainment functionality and provide additional redundancy for emergency situations.

Controllers 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be coupled to multiple nodes, each with its own unique identifier (CAN ID). A controller may read information from the bus to find a steering wheel angle, ground speed, engine rotations-per-minute (RPM), button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the CAN bus of vehicle 102 and controllers 114, forwarding vehicle data to controllers 114 including data regarding turn signal activation, wheel speed, acceleration, pitch, roll, yaw, Global Positioning System (“GPS”) data, tire pressure, fuel level, SONAR, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controllers 114 may provide autonomous driving outputs in response to an array of sensor inputs from the following sensors, including, for example: one or more ultrasonic sensors 124 (e.g., a SONAR sensor), one or more RADAR sensors 126, one or more LIDAR sensors 128, one or more surround cameras 130 (typically such cameras are located at various places on vehicle body 104 to image areas all around the vehicle body), one or more cameras 132 (in one example, at least one such camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controllers 114 may also receive inputs from an instrument cluster 148 and may provide human-perceptible outputs to a human operator via one or more human-machine interface (“HMI”) displays 150, an audible annunciator, a loudspeaker, steering wheel feedback, and/or other means. In addition to traditional information such as velocity, time, and other well-known information, HMI display 150 may provide the vehicle occupants with information regarding maps and vehicle's location, the location of other vehicles (including an occupancy grid) and the identification of objects and status. For example, HMI display 150 may alert the passenger when controllers 114 have determined that vehicle 102 is moving across lane boundaries. In some examples, HMI display 150 may alert the passenger when controllers 114 have identified the presence of a stop sign, caution sign, or changing traffic light and is taking appropriate action, giving the vehicle occupants peace of mind that controllers 114 are functioning as intended. In one example, instrument cluster 148 may include a separate controller/processor configured to perform deep learning and artificial intelligence functionality.

Vehicle 102 may collect data that are used to help train and refine the neural networks used for autonomous driving. Vehicle 102 may include a modem 152, preferably a system-on-a-chip that provides modulation and demodulation functionality and allows controllers 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 may include wireless functionality substantially compliant with one or more wireless protocols such as, without limitation: LTE, WCDMA, UMTS, GSM, CDMA2000, or other known and widely used wireless protocols.

Vehicle 102 may include a plurality of cameras 130-134 configured to capture images around all or a portion of a periphery of vehicle 102. Camera type and lens selection may depend on the nature and type of function. Vehicle 102 may have a mix of camera types and lenses to provide complete coverage around vehicle 102. In general, narrow lenses do not have a wide field of view but can see farther. One or more camera locations on vehicle 102 may support interfaces such as Gigabit Multimedia Serial link (GMSL) and Gigabit Ethernet.

Vehicle 102 may be configured with sensors that provide access to a 360-degree surround representation of the environment for safe and efficient navigation. A multi-camera sensor and depth sensor system may be configured to reliably capture a complete surrounding representation around vehicle 102 by aggregating pixel level information from cameras 130-134 with depth, geometry, and/or velocity information from a depth sensor. In addition, though not shown in the example of FIG. 1, other example depth sensors may be used in conjunction with the techniques of this disclosure, including infrared depth sensors, structured light sensors, and/or time-of-flight (ToF) camera sensors.

In some example perception models, 3D depth data from a depth sensor (e.g., a RADAR point cloud) is processed by a depth feature extractor to obtain depth feature vectors. The 3D depth features vectors may then be flattened into a birds-eye-view (BEV) representation. Additionally, one or more camera images captured at approximately the same time as the 3D depth data may be processed by a camera feature extractor to obtain camera feature vectors. These camera feature vectors may be processed by a view transformation to convert the camera features from perspective views into the same BEV representation as the depth feature vectors. One example of a view transformation is lift, shoot, splat (LST). As part of the lift, shoot, splat process, implicit depth estimation is performed for each of the camera feature vectors.

A BEV representation in computer vision refers to a top-down perspective of a scene, as if viewed from above, similar to the perspective of a bird flying overhead. A BEV representation may be particularly valuable in applications such as autonomous driving, robotics, and surveillance, where understanding the spatial layout and relationships between objects on a ground plane is beneficial. In the context of computer vision, generating a BEV representation involves transforming image data from one or more cameras into a top-down view. This top-down perspective simplifies various tasks in computer vision, such as object detection, tracking, and path planning, by reducing the complexity of the scene and offering a more intuitive understanding of spatial relationships. Additionally, as discussed above, BEV representations are often integrated with data from other sensors, such as LIDAR or RADAR, to enhance accuracy and robustness in dynamic and complex environments.

In accordance with one or more techniques of this disclosure, controller 114 may obtain sensor data from a plurality of sensors, such as ultrasonic sensors 124, RADAR sensors 126, LIDAR sensors 128, surround cameras 130, cameras 132, and infrared camera 134. The sensor data includes representations of objects detected by the sensors. The objects may comprise one or more first detected objects that are at distances less than a designated distance and/or one or more second detected objects that are at distances greater than the designated distance. Controller 114 may generate a Bird's Eye View (BEV) feature tensor that represents the one or more first detected objects projected onto a BEV surface. Additionally, controller 114 may generate a Generalized Perspective View (GPV) feature tensor that represents the second detected objected projected onto a GPV surface. A BEV grid of the BEV surface (e.g., a grid of coordinate positions on the BEV surface) and a GPV grid of the GPV surface (e.g., a grid of coordinate positions on the GPV surface) are defined such that sector lines of the BEV grid and column lines of the GPV grid are aligned. Controller 114 may concatenate the BEV feature tensor and the GPV feature tensor along the sector lines of the BEV grid and the column lines of the GPV grid to generate a concatenated tensor. Controller 114 may perform one or more perception tasks based on the concatenated tensor. One or more actions may be performed based on results of the perception tasks. For example, controller 114 may cause vehicle 102 to accelerate, decelerate, or turn. Generating and concatenating the BEV feature tensor and the GPV feature tensor in this way may help to conserve computational resources by avoiding the representation of more distant elements in the BEV feature tensor while also reducing ghosting issues that may arise in GPV representations from the use of sensor data obtained from sensors at different positions.

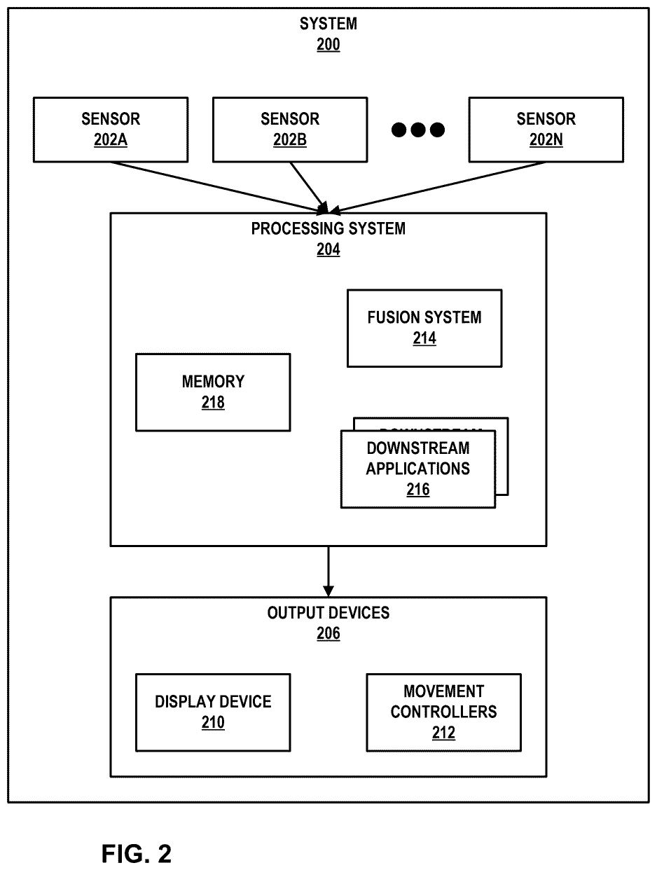

FIG. 2 is a block diagram illustrating an example system 200 that includes a plurality of sensors 202A-202N (collectively, “sensors 202”), a processing system 204, and one or more output devices 206, in accordance with one or more techniques of this disclosure. In various examples, system 200 may be part of a vehicle, smartphone, mobile device, computing device, robot, or other type of device. Example types of vehicles include cars, trucks, boats, ships, aircraft, and so on. In some examples, sensors 202, processing system 204, and output devices 206 are included in, or attached to, the same physical device. In some examples, one or more of sensors 202, processing system 204, and output devices 206 may be included in, or attached to, two or more physical devices. For instance, sensors 202 and processing system 204 may be in a first device of system 200 and output devices 206 may be in a second device of system 200.

Sensors 202 are configured to generate sensor data, such as optical image data, optical video data, depth image/video data, night-vision image/video data, LIDAR data, and so on. Sensors 202 may include cameras, LIDAR devices, or other types of sensors that generate sensor data. For instance, with reference to FIG. 1, sensors 202 may include any of ultrasonic sensors 124, RADAR sensors 126, LIDAR sensors 128, surround cameras 130, cameras 132 (e.g., stereo or mono cameras), infrared cameras 134, and so on. Sensors 202 may be positioned at various locations around system 200. For instance, in an example where system 200 is a vehicle, sensors 202 may include one or more forward-facing sensors, one or more rear-facing sensors, one or more left-side sensors, one or more right-side sensors, trailer sensors, underbody sensors, cargo bed sensors, and so on.

Processing system 204 may comprise one or more discrete hardware units within system 200. For example, processing system 204 may include a modular, self-contained unit of hardware within system 200. In different examples, processing system 204 may or may not be connected to a motherboard shared with processing system 204. In some instances, this disclosure may refer to processing system 204 as a “core.” A role of processing system 204 is to preprocess image data generated by sensors 202 prior to use of the image data by processing system 204. Examples of preprocessing the image data may include harmonizing characteristics of image data across sensors 202, synchronizing image data, regularizing illumination levels across sensors 202, correcting for lens distortion, increase gain at corners of images, and other tasks that ready the image data for use by processing system 204. Processing system 204 may be part of a larger pipeline for processing image data. With respect to the example of FIG. 1, controllers 114 may include processing system 204.

Processing system 204 may include one or more processing units (i.e., processors). In some examples, processing system 204 may include a pipeline of processors. Processing system 204 may obtain image data that has been preprocessed by processing system 204. Processing system 204 may use the image data for one or more purposes. In some examples, processing system 204 may apply one or more filters to the image data. In an example where system 200 is a vehicle or robot, processing system 204 may use the image data for navigation. With reference to FIG. 1, one or more of controllers 114 may include processing system 204.

Processing system 204 may cause output devices 206 to produce various types of output. For instance, in the example of FIG. 2, output devices 206 include a display device 210. Processing system 204 may cause display device 210 to display images and/or video based on the image data generated by one or more of sensors 202 or based on output data generated by processing system 204. Additionally, in the example of FIG. 2, output devices 206 may include one or more movement controllers 212. Movement controllers 212 may perform actions to move one or more devices of system 200. For instance, in an example where system 200 is a vehicle, movement controllers 212 may steer, accelerate, or brake the vehicle. In an example where system 200 is a robot, movement controllers 212 may cause different portions of the robot to move in particular ways. It is to be understood that display device 210 and movement controllers 212 are provided in FIG. 2 as examples of output devices 206 and not all examples include either or both display device 210 and movement controllers 212, and that output devices 206 may include other types of devices and systems. In some examples, one or more of controllers 114 include movement controllers 212.

Processing system 204 may be implemented as any of a variety of suitable circuitry components, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

In the example of FIG. 2, processing system 204 includes a fusion system 214, one or more downstream applications 216, and one or more memories 218. Fusion system 214 and downstream applications 216 may be associated with processor-executable instructions that are executable by processors of processing system 204. Execution of such instructions by the one or more processors may cause processing system 204 to provide the functionality ascribed in this disclosure to fusion system 214 and downstream applications 216. In some examples, some or all functionality of fusion system 214 and/or downstream applications 216 is provided by special-purpose processors of processing system 204. In some examples, the processor-executable instructions are stored in memories 218. Memories 218 may include one or more non-transitory computer-readable storage media. Memories 218 may be configured to store sensor data obtained from of sensors 202.

In general, fusion system 214 is configured to fuse sensor data from sensors 202 to generate output data for use by downstream applications 216. Downstream applications 216 may perform various activities using output data generated by fusion system 214. For example, one or more of downstream applications 216 may use the output data to determine actions to take for autonomous navigation, enhanced driver assistance, and so on.

In accordance with the techniques of this disclosure, fusion system 214 may obtain sensor data from sensors 202. The sensor data includes representations of objects detected by the sensors. The objects may include one or more first detected objects that are at distances less than a designated distance and one or more second detected objects that are at distances greater than the designated distance. The objects may be complete physical objects or portions of physical objects. For instance, an object may be a portion of a stop sign. The representations of the object may include groups of pixels or voxels having color values indicating a color of a surface the object, points of a point cloud indicating detected positions of a surface of the object, and other ways of representing objects.

Fusion system 214 may generate a BEV feature tensor that represents the one or more first detected objects projected onto a BEV surface. In general, the BEV feature tensor does not contain information representing the one or more second detected objects. Fusion system 214 may also generate a Generalized Perspective View (GPV) feature tensor that represents the one or more second detected objects projected onto a GPV surface. In general, the GPV feature tensor does not contain information representing the one or more first detected objects.

The BEV surface may comprise a plane centered on an origin point and having an outer boundary. The outer boundary may be elliptical (e.g., circular, ovoid, etc.), rectangular, rectangular, or have another shape. In general, the plane corresponds to a surface over which a vehicle is moving (e.g., road, floor, water surface, runway, etc.). A BEV grid is a grid of coordinate positions on the BEV surface. The BEV grid may be defined in terms of polar coordinates (e.g., a yaw angle and a radial distance). A GPV surface may comprise at least a portion of a spherical segment, an annular plane, or another type of surface having a focal point at an origin point of the BEV surface. A GPV grid is a grid of coordinate positions on the GPV surface. The GPV grid may be defined in terms of yaw angles and pitch angles (elevation angles). In accordance with one or more techniques of this disclosure, the BEV grid of the BEV surface and the GPV grid of the GPV surface are defined such that sector lines of the BEV grid and column lines of the GPV grid are aligned.

Fusion system 214 may concatenate the BEV feature tensor and the GPV feature tensor along the sector lines of the BEV grid and the column lines of the GPV surface grid to generate a concatenated tensor. Aligning the sector lines of the BEV grid and column lines of the GPV grid may allow the concatenation process to work efficiently and may prevent the occurrence of moiré artifacts. That is, moiré artifacts may arise from the BEV grid and the GPV grid being out of alignment. Fusion system 214, one or more downstream applications 216 or another unit of system 200 may perform perception tasks based on the concatenated tensor. In some examples, one or more perception tasks may be performed based on the concatenated tensor to generate output data representing results of the one or more perception tasks. For example, a neural network may be applied to the concatenated tensor to perform one or more perception tasks, thereby generating output data representing results of the one or more perception tasks. Example perception tasks may include one or more of sematic segmentation, semantic occupancy prediction, lane tracking, object tracking, collision prediction, 3D object detection, or 3D object classification. In such examples, the output data may be used for performing physical actions, such as ADAS or autonomous navigation. In some examples, fusion system 214, one or more downstream applications 216, or another unit of system 200 may apply a neural network to the concatenated tensor to generate output data that is used as input to systems that perform the perception tasks.

Output devices 206 may perform action based on results of the perception tasks. For example, one or more of downstream applications 216 may determine detect an object on a roadway and instruct one or more of movement controllers 212 to perform actions to avoid the object.

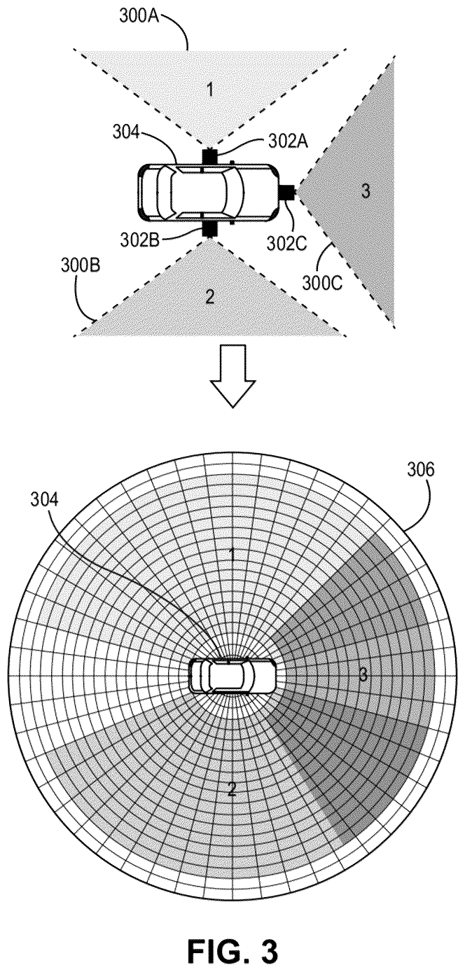

FIG. 3 is a conceptual diagram illustrating projection of perspective views 300A, 300B, 300C of sensors 302A, 302B, 302C of a vehicle 304 onto a BEV surface 306. In the example of FIG. 3, each of sensors 302A, 302B, and 302C (collectively, “sensors 302”) has its own viewing perspective on an area around vehicle 304. Fusion system 214 may project elements detected by sensors 302 onto positions within BEV surface 306. The perspective views 300A, 300B, 300C (collectively, “perspective views 300”) may overlap. As a result, fusion system 214 may map detected objects from sensor data from two or more of sensors 302 into a single location on BEV surface 306. In the example of FIG. 3, a BEV grid of BEV surface 306 may have an origin point centered within vehicle 304.

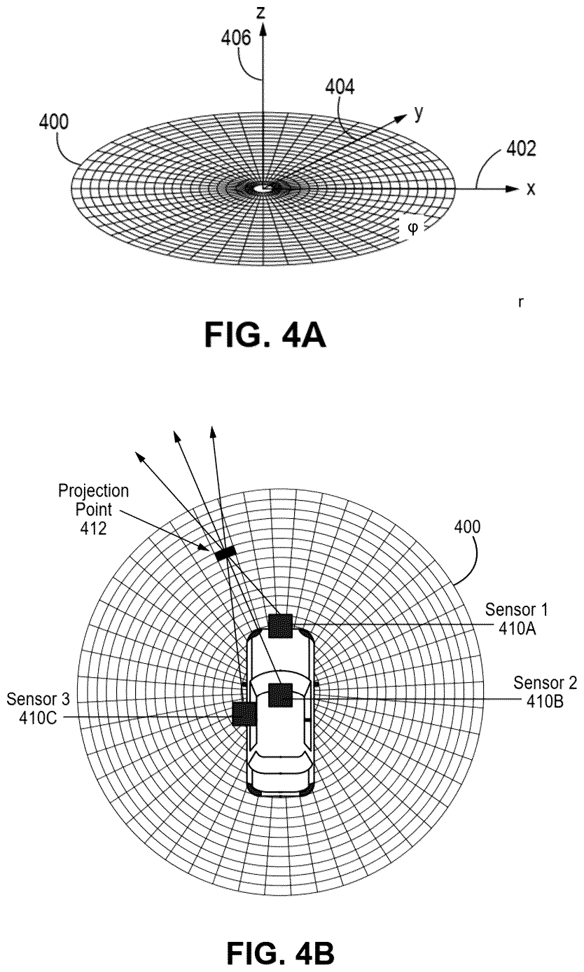

FIG. 4A is a conceptual diagram illustrating dimensions of a BEV grid 400. Positions in BEV grid 400 may be defined in terms of a radius coordinate 402 (labeled r), a yaw angle (azimuth) coordinate 404 (labeled φ), and an elevation coordinate 406 (labeled z). BEV grids are commonly used for sensor fusion because objects are relatively easy to project onto a horizontal plane of a BEV surface from different sensor locations. FIG. 4B is a conceptual diagram illustrating projection of objects detected by a set of sensors 410A, 410B, and 410C (collectively, “sensors 410”) into a single position (e.g., a projection point 412) in BEV grid 400. Fusion system 214 may determine projection point 412 using geometry, given the locations of sensors 410. Fusion system 214 may obtain information regarding projection point 412 based on sensor data from sensors 410A, 410B, and 410C and may encode the information regarding projection point 412 into a corresponding cell of a tensor (i.e., a BEV feature tensor) that represents detected elements in BEV grid 400.

There may be several drawbacks to using BEV grids. For example, a BEV grid can only represent detected elements within the extent of the BEV grid, which has a limited radius. Additionally, it may be very expensive in terms of storage and processing resources to increase the extent or radius of a BEV grid. This may be exacerbated by the fact that a z-collapsed representation may be used for encoding information above each cell in the elevation dimension. In other words, each cell of a BEV feature tensor may correspond to a location in a horizontal plane of the BEV grid. The cell of BEV feature tensor may store all information about detected objects in the corresponding location in the horizontal plane of the BEV grid and detected objects in locations above the corresponding location in the elevation dimension. The detected objects above the corresponding location in the elevation dimension may be sparse. Furthermore, information about detected objects that are perpendicular to the horizontal plane of BEV grid 400 may be hard to represent in the horizontal plane of BEV grid 400 and may not be particularly suitable for the z-collapsed representation. Examples of detected objects in locations perpendicular to the horizontal plane of BEV grid 400 may include objects corresponding to traffic signs, text on signs, traffic lights, and so on.

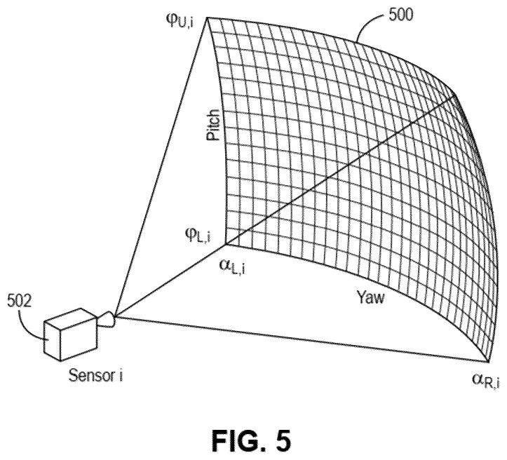

FIG. 5 is a conceptual diagram illustrating an example perspective view surface 500 of a single camera 502. Perspective view surface 500 is typically a mostly vertical surface. A location of perspective view surface 500 may be defined by an origin position of camera 502 and an orientation. An extent of perspective view surface 500 may be defined by yaw and pitch limits. Thus, perspective view surface 500 may be a segment of a sphere with one base. In some examples, perspective view surface 500 is an outward projection of an image sensor through a lens of camera 502.

Perspective view surfaces and their grids may work well for single sensor systems but may be problematic for fusion in multi-sensor systems. For example, each sensor has its field of view limited by the maximum boundaries for pitch and yaw: [(φ_{U,i} φ_{L,i}] and [α_{L,i}, α_{R,i}]. The absolute values of these boundaries may be determined at runtime by using sensor calibration processes estimating the current orientation and position of the sensor relative to the ego vehicle reference coordinate system. This may increase use of computational resources in order to harmonize the perspective views.

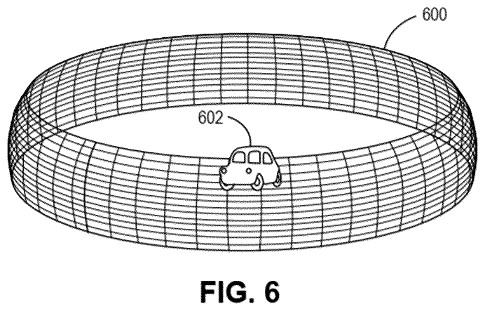

FIG. 6 is a conceptual diagram illustrating an example generalized perspective view (GPV) surface 600. GPV surface 600 is a generalization of a perspective view. GPV surface 600 covers a 360° range in a horizontal plane surrounding a vehicle 602.

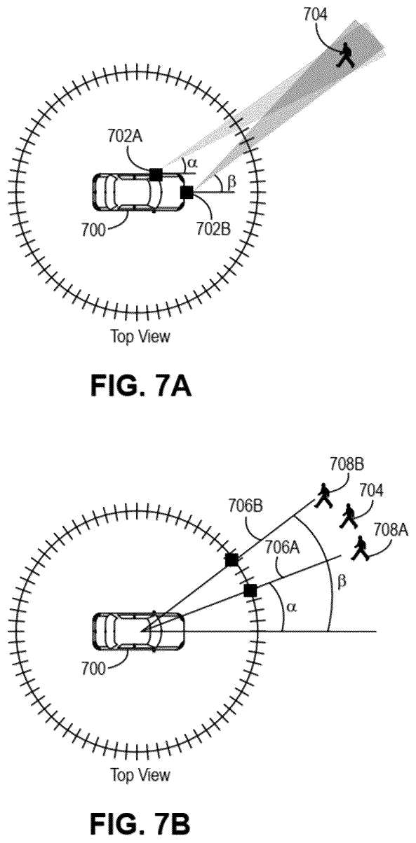

FIG. 7A and FIG. 7B are conceptual diagrams illustrating a top view of a vehicle 700 with sensors 702A, 702B (collectively, “sensors 702”) that are not positioned at an origin point of a GPV surface. Problems may arise when using a GPV surface when sensor fusion uses sensor data from sensors, such as sensors 702 that do not coincide with an origin point of the GPV surface. For example, incorrect yaw angle estimates may be generated for an object. For instance, as shown in FIG. 7A, α indicates an angle between a line extending from sensor 702A in a forward direction of the vehicle and a line extending from sensor 702A to a pedestrian 704. β indicates an angle between a line extending from sensor 702B in the forward direction of the vehicle and a line extending from sensor 702B to pedestrian 704. The angle α has a different value from the angle 3. As shown in FIG. 7B, when the positions of sensors 702 are translated to an origin point of the GPV surface, lines 706A, 706B extending at angles α and β from the origin point indicate that pedestrian 704 is at two different positions simultaneously. The result is that “ghost” objects 708A, 708B (collectively, “ghost objects”) appear. The distance between ghost objects, such as ghost objects 708, is greater for nearby objects than for more distant objects. This difference in distance between ghost objects based on distance from the origin point may make it more difficult to merge the ghost objects to determine a true position of an object (e.g., pedestrian 704).

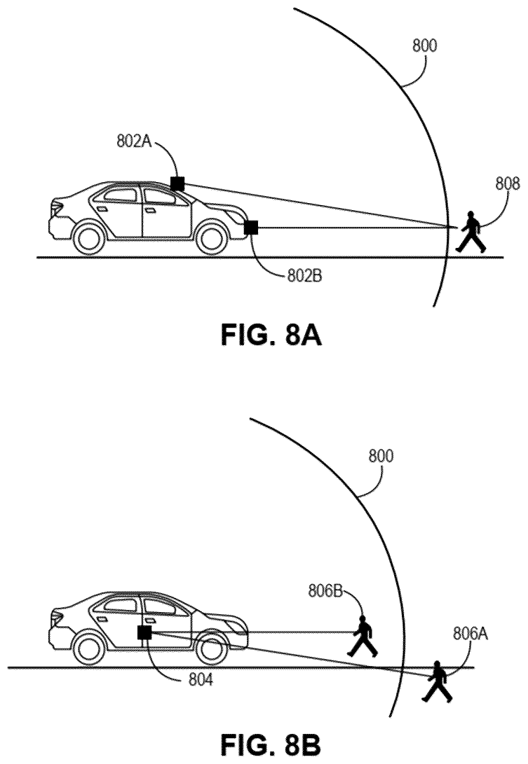

FIG. 8A and FIG. 8B are conceptual diagrams illustrating a GPV surface 800 and ghosting problems may occur in the elevation direction. Specifically, when the origin points of perspective views generated by sensors 802A, 802B (collectively, “sensors 802”) are translated to an origin point 804 of GPV surface 800, ghost objects 806A, 806B (collectively, “ghost object 806”) may be detected at different elevation positions instead of a true position of a real object, e.g., pedestrian 808.

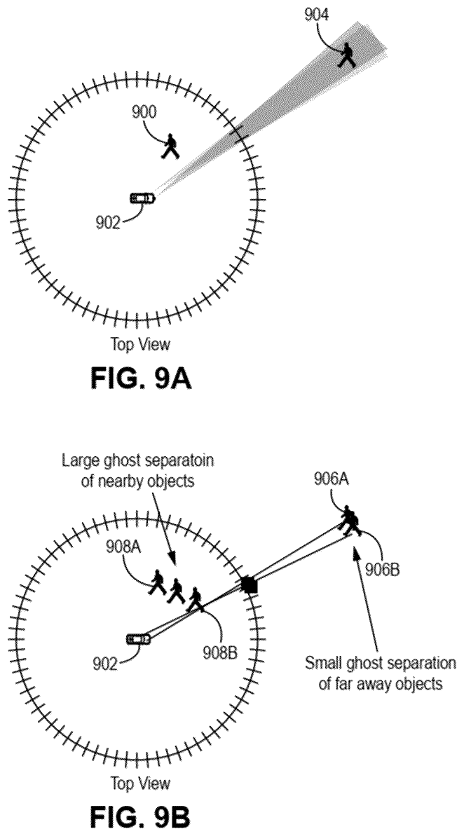

FIG. 9A and FIG. 9B are conceptual diagrams illustrating that distances between ghost objects vary based on distance from the origin of a GPV surface. For instance, as shown in FIG. 9A, a first pedestrian 900 is closer to a vehicle 902 than a second pedestrian 904. As shown in FIG. 9B, ghost elements 908A, 908B associated pedestrian 900 are further apart than ghost elements 906A, 906B associated pedestrian 904.

It is therefore apparent that the use of BEV surfaces and GPV surfaces have their relative advantages and disadvantages for sensor fusion. This disclosure describes techniques that may overcome these deficiencies. As described herein, detected objects may be represented in a fusion surface that combines a BEV surface and a GPV surface.

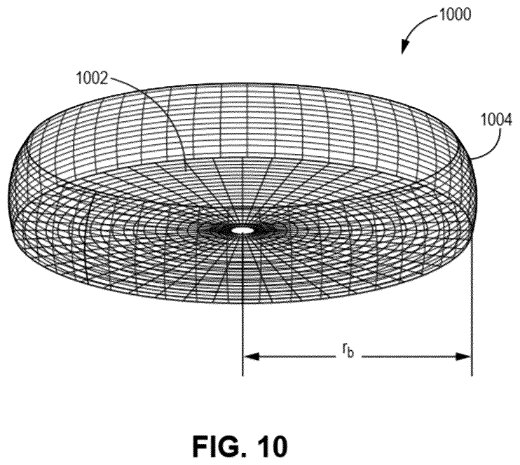

FIG. 10 is a conceptual diagram illustrating an example feature fusion surface 1000, in accordance with one or more techniques of this disclosure. Feature fusion surface 1000 is a surface that comprises two parts: a BEV surface 1002 and a GPV surface 1004 placed concentrically to BEV surface 1002. BEV surface 1002 may be used for detections up to a designated distance, re. GPV surface 1004 may be used for detections at or beyond the designated distance. A BEV grid of BEV surface 1002 and a GPV grid of GPV surface 1004 may be defined such that sector lines of the BEV grid and column lines of the GPV grid are aligned. For example, an azimuth coordinate value in the BEV grid corresponds the same azimuth relative to an origin point as an azimuth coordinate value in the GPV grid.

When a lift, splat, shoot (LSS) method or another z-collapsing method is applied, detected objects with distances less than the radius (re) of BEV surface 1002 are represented in a BEV feature tensor. Detected objects with distances larger than the radius (re) are represented in a GPV feature tensor, where the distances of the detected objects are encoded in the channels of cells of the GPV feature tensor.

The radius (rb) may be determined (e.g., by fusion system 214) in one of a variety of ways. BEV compute costs may grow rapidly with increasing radius. Therefore, if minimizing compute costs is a priority, a smaller radius may be determined. On the other hand, the closer objects are to the vehicle, the larger the parallax becomes between sensors.

Although the GPV fusion has a significant receptive field to cover most ghost element copies, the point of view changes. In an extreme case, where the sensors include fish-eye lenses with 190° horizontal fields of view (hFoV) placed 90 degrees apart, the two cameras may see the same vehicle from perpendicular directions (e.g., one has a side view, and the other a rear view). This may prevent a convolutional neural network (CNN)-based neural network from matching the two images of the vehicle in an acceptable fashion. As the detected elements become more distant, the points of view converge and the fusion on the PV cylinder becomes possible, hence making fusion easier with lower compute cost. Therefore, GPV fusion is relatively “cheap” at large re in terms of compute costs. Another boundary condition is that, since little information below the ground level is useful in the GPV grid, the lower limit of the GPV vertical field of view (vFoV) may be set to coincide with where a ray intersects with re at the ground plane, so there is no gap between the GPV and BEV surfaces.

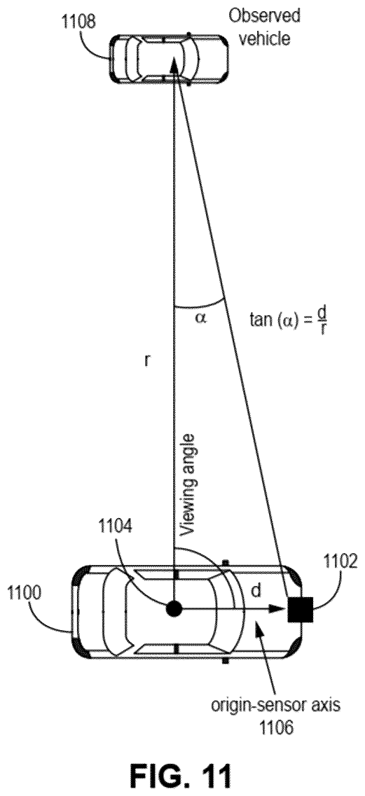

FIG. 11 is a conceptual diagram illustrating that a largest parallax occurs when an origin-sensor axis is perpendicular to the viewing angle of an object. Particularly, in the example of FIG. 11, a vehicle 1100 has a sensor 1102. An origin 1104 of a BEV surface is located at a center of vehicle 1100. An origin-sensor axis 1106 extends from origin 1104 to sensor 1102. The distance from origin 1104 to sensor 1102 is denoted as d. Another vehicle 1108 is located at a position perpendicular to origin-sensor axis 1106 at a distance r. α indicates a maximum viewing shift angle. A minimum distance required for GPV fusion may be:

$${r}_{min} = \frac{d}{tan ( α )}$$

$${α}_{max} = arctan ( \frac{d}{r} )$$

Since the cost to cope with different viewpoints grows with the magnitude of the difference (αₘₐₓ), the cost also grows inversely with the minimum distance.

$$Cost = BEV + PV ∼ {r}^{2} + \frac{1}{r}$$

re may therefore be determined so that the sum of the costs are minimized. In the equation above, the symbol ~ means that BEV+PV behaves asymptotically with respect to

$${r}^{2} + \frac{1}{r} .$$

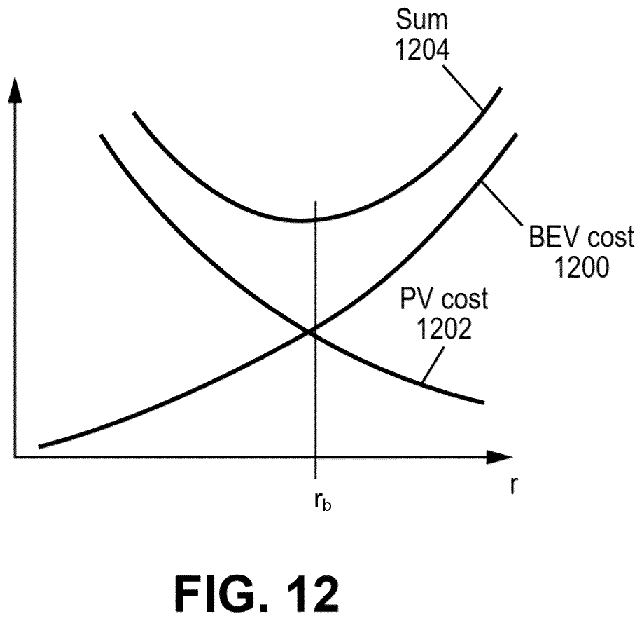

FIG. 12 is a conceptual diagram illustrating a BEV cost function 1200, a PV cost function 1202, and a sum cost function 1204. BEV cost function 1200 shows costs rising with increasing radius. PV cost function 1202 shows costs falling with increasing radius. Sum cost function 1204 is a sum of BEV cost function 1200 and PV cost function 1202. BEV cost function 1200 and PV cost function 1202 may each be determined using a combination of a first-principles analysis (e.g., analyzing the algorithm itself) and an empirical study (e.g., analyzing the system resource consumption for different parametrizations of the grid and networks). The selected radius (re) may be found at a minimum point of sum cost function 1204. Thus, in some examples, fusion system 214 may determining the designated distance (re) based on a computational cost of the BEV grid and a computational cost of the GPV grid.

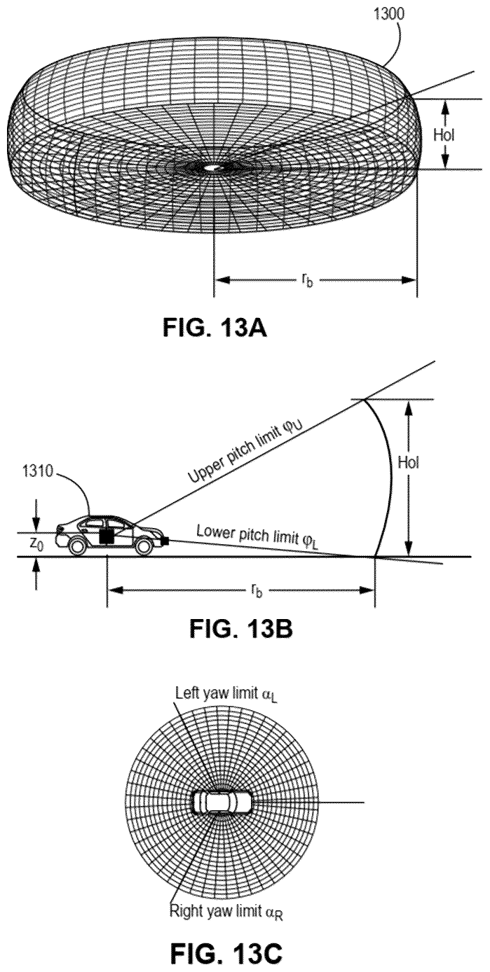

FIG. 13A is a conceptual diagram illustrating an example height of a GPV surface 1300, in accordance with one or more techniques of this disclosure. FIG. 13B is a conceptual diagram illustrating an example height relative to a vehicle 1310, in accordance with one or more techniques of this disclosure. FIG. 13C is a conceptual diagram illustrating an example left and right yaw limit in accordance with one or more techniques of this disclosure.

Given that an re has been determined, the Height of Interest (HoI) is selected based on the application requirements of the heights of structures that need to be captured at this distance (and beyond), (limited by the vertical field of view the sensors). The HoI may indicate the required height for what the model covers. With HoI determined, the pitch limits of the GPV surface, φ_{L} and φ_{U}, can be computed:

$${φ}_{U} = atan ( \frac{HoI - {z}_{0}}{{r}_{b}} )$$

$${φ}_{L} = - atan ( \frac{{z}_{0}}{{r}_{b}} )$$

The information below φ_{L} and above _{U} are omitted from the GPV projection. Similarly, is the yaw limits α_{L} and α_{R} determined from the application requirements. In a typical scenario they encompass 360 degrees:

$${α}_{L} = - 1 \; 80 degrees$$

$${α}_{R} = 180 degrees$$

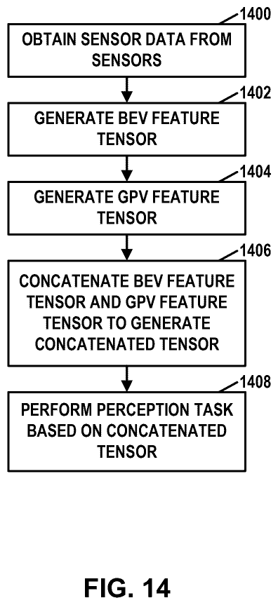

FIG. 14 is a flowchart illustrating an example operation of fusion system 214, in accordance with one or more techniques of this disclosure. In the example of FIG. 14, fusion system 214 obtains sensor data from a plurality of sensors 202 (1400). The sensor data includes representations of objects (e.g., people, traffic signs, a roadway, etc.) detected by the sensors. The objects may include one or more first detected objects that are at distances less than a designated distance and one or more second detected objects that are at distances greater than the designated distance. The representations of the objects may include pixels values in images, points in point clouds, and other ways of representing physical world objects detected by sensors 202.

Fusion system 214 may generate a BEV feature tensor that represents the one or more first detected objects projected onto a BEV surface (1402). The BEV surface may comprise a horizontal plane (which may be circular, ovoid, etc.) surrounding an origin point. The origin point may correspond to a center of a vehicle. The BEV feature tensor may comprise cells that correspond to locations on the BEV surface. Locations on the BEV surface may be specified in terms of yaw angles and radius distances. In this way, locations on the BEV surface may be defined within a BEV grid having sector lines corresponding to yaw angles and radius lines corresponding to radius distances. In some examples, locations on the BEV surface are specified in terms of Cartesian coordinates (e.g., x, y coordinates). Fusion system 214 may store information related to the one or more first detected objects into cells of the BEV feature tensor that correspond to locations of the one or more first detected objects. For example, the BEV feature tensor may include a cell that corresponds to a location with a yaw angle α and a radius position r in a BEV grid of the BEV surface. In another example, the BEV feature tensor may include a cell that corresponds to a location with an x-coordinate x and a y-coordinate y in a BEV grid of the BEV surface.

Fusion system 214 may generate a GPV feature tensor that represents at least the second detections projected onto a GPV surface (1404). The GPV feature tensor may comprise cells that correspond to locations on a GPV surface. Locations on the GPV surface may be specified in terms of yaw angles and pitch angles. In this way, locations on the GPV surface may be defined within a GPV grid with columns corresponding to yaw angles and rows corresponding to pitch angles. Fusion system 214 may store information related to the one or more second detected objects into cells of the GPV feature tensor that correspond to locations of the one or more second detected objects. For example, the GPV feature tensor may include a cell that corresponds to a location with a yaw angle α and a pitch angle φ in a GPV grid of the GPV surface. In some examples, the GPV feature tensor may also represent the first detections projected onto the GPV surface. That is, fusion system 214 may also store information related to the one or more first detected objects into cells of the GPV feature tensor that correspond to locations of the one or more first detected objects.

The BEV grid and the GPV grid may be defined such that sector lines of the BEV grid and column lines of the GPV grid are aligned. Thus, the same value of a yaw angle in the BEV grid and the GPV grid indicates that same yaw angle relative to the origin point.

Fusion system 214 may concatenate the BEV feature tensor and the GPV feature tensor along the sector lines of the BEV grid and the column lines of the GPV surface grid to generate a concatenated tensor (1406). For example, columns of the concatenated tensor may correspond to yaw angles while rows of the concatenated tensor derived from the BEV feature tensor may correspond to radial distances and rows of the concatenated tensor derived from the GPV feature tensor may correspond to pitch angles. In other examples, columns and rows may be reversed.

Fusion system 214 may perform one or more perception tasks based on the concatenated tensor (1408). For example, fusion system 214 may apply one or more neural network models to the concatenated tensor to generate output data. The output data may represent results of the one or more perception tasks. In some examples, the output data may serve as input to the one or more perception tasks. In some examples, the results of the perception tasks may include data representing one or more of: objects, vulnerable road users, or roadway boundaries.

In some examples, system 200 may perform one or more actions based on results of the one or more perception tasks. For example, movement controllers 212 may control a vehicle or robot based on the results of the perception tasks.

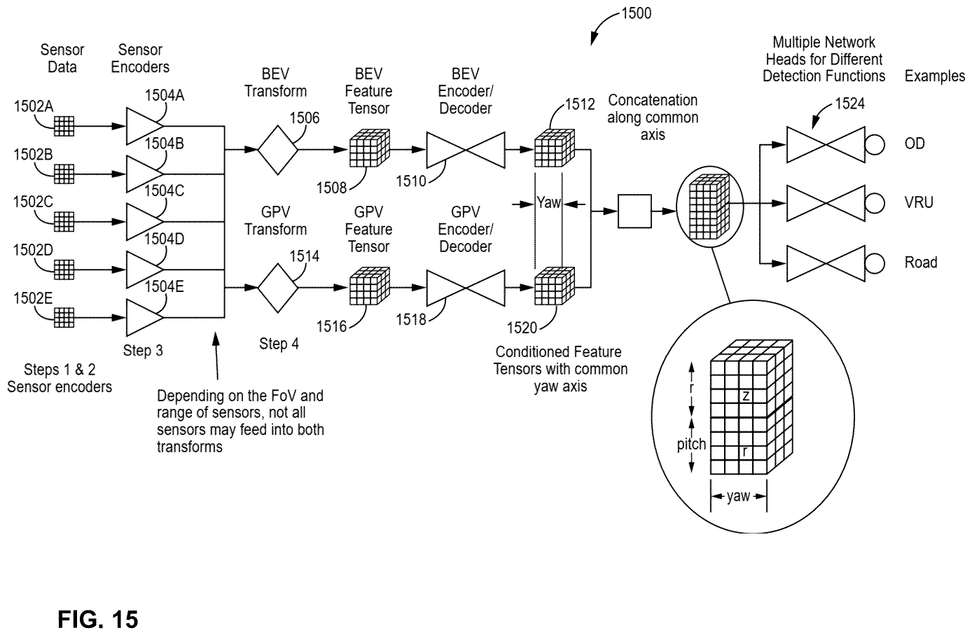

FIG. 15 is a conceptual diagram illustrating an example software architecture 1500 of fusion system 214, in accordance with one or more techniques of this disclosure. In the example of FIG. 15, fusion system 214 may obtain sets of sensor data 1502A-1502E (collectively, “sensor data 1502”) from sensors 202. In other examples, fusion system 214 may receive other quantities of sets of sensor data. In some examples, one or more sets of sensor data 1502 comprises a 2-dimensional grid of pixels. In some examples, one or more sets of sensor data 1502 comprises a set of point cloud data.

Additionally, fusion system 214 comprises a set of sensor encoders 1504A-1504E (collectively, “sensor encoders 1504”). Sensor encoders 1504 may be trained as part of training architecture 1500 as a whole. Fusion system 214 may apply sensor encoders 1504 to respective sets of sensor data 1502 to generate sets of encoded sensor data.

In some examples, each of sensor encoders 1504 is implemented as a convolutional neural network (CNN). The CNN may include convolutional operations, ReLU activations, max pooling, and skip connections. As an encoder network, the CNN may reduce the spatial dimensionality from an image (e.g., a 1920×960 full image) to something that works for a view transform (e.g., 16×128) where vertical information is downsampled more that the horizontal direction (e.g., 1920 to 128 vs. 960 to 16) to fit the compute structure of a digital signal processors. A major function of the CNN is to reduce the spatial dimensions, while placing feature information into the channels of the tensor, rather than in the spatial dimension.

Fusion system 214 may apply a BEV transform 1506 to the sets of encoded sensor data to generate an initial BEV feature tensor 1508. Initial BEV feature tensor 1508 may comprise a multi-dimensional array. Cells of initial BEV feature tensor 1508 correspond to different locations on a BEV surface. Thus, in some examples, a first dimension of initial BEV feature tensor 1508 may correspond to yaw angles and a second dimension of initial BEV feature tensor 1508 may correspond to radius distances. A third dimension (e.g., a channel dimension) of initial BEV feature tensor 1508 may correspond to channels that provide different types of information about locations on the BEV surface. In some examples, the first dimension of initial BEV feature tensor 1508 corresponds to x coordinates and the second dimension of initial BEV feature tensor 1508 corresponds to y coordinates.

Next, fusion system 214 applies a BEV encoder/decoder 1510 to initial BEV feature tensor 1508 to generate a BEV feature tensor 1512 (e.g., a conditioned BEV feature tensor). BEV encoder/decoder 1510 may comprise an autoencoder model that comprises a CNN-based encoder and a CNN-based decoder. The CNN-based encoder comprises a series of convolutional layers that generate an encoded feature tensor based on initial BEV feature tensor 1508. The dimensionality of the encoded feature tensor may be less than the dimensionality of initial BEV feature tensor 1508. The CNN-based decoder comprises a series of convolutional layers that generate BEV feature tensor 1512. BEV feature tensor 1512 may have the same dimensionality as initial BEV feature tensor 1508.

The encoder of BEV encoder/decoder 1510 may reduce dimensionality of initial BEV feature tensor 1508. The two spatial axes of initial BEV feature tensor 1508 may represent a flat surface around a vehicle (e.g., x/y or r/phi). The spatial dimensions of initial BEV feature tensor 1508 may be different in different examples, and may depend on cell resolution, which in turn may be dependent on feature resolution and function key performance indicators (KPIs). The KPS may include properties and qualities for the detected functions, for example detection range, false-positive rate or true-positive rate. For example, dimensions of initial BEV feature tensor 1508 may be 128×128, 128×512, 256×256 or 192×192, depending on the exact solution. The decoder of BEV encoder/decoder 1510 may be much like the encoder of BEV encoder/decoder 1510, but in reverse. The decoder of BEV encoder/decoder 1510 may increase the spatial dimensions. In different examples, BEV feature tensor 1512 may or may have the same resolution as initial BEV feature tensor 1508. In some examples, both initial BEV feature tensor 1508 and BEV feature tensor 1512 have a resolution of 256×256. In some examples, initial BEV feature tensor 1508 has a resolution of 128×128 and BEV feature tensor 1512 has a resolution of 256×256. In some examples, a factor relating the resolutions of initial BEV feature tensor 1508 and BEV feature tensor 1512 is radix-2. In some examples, there are one or more skip connections between the encoder and decoder of BEV encoder/decoder 1510.

Fusion system 214 may apply a GPV transform 1514 to the sets of encoded sensor data to generate an initial GPV feature tensor 1516. Initial GPV feature tensor 1516 may comprise a multi-dimensional array. Cells of initial GPV feature tensor 1516 correspond to different locations on a GPV surface. Thus, a first dimension of initial GPV feature tensor 1516 may correspond to yaw angles and a second dimension of initial GPV feature tensor 1516 may correspond to pitch angles. A third dimension (e.g., a channel dimension) of initial GPV feature tensor 1516 may correspond to channels that provide different types of information about locations on the BEV surface. In some examples, the first dimension of initial GPV feature tensor 1516 corresponds to x coordinates and the second dimension of initial GPV feature tensor 1516 corresponds to y coordinates.

Next, fusion system 214 applies a GPV encoder/decoder 1518 to initial GPV feature tensor 1516 to generate a GPV feature tensor 1520 (e.g., a conditioned GPV feature tensor). GPV encoder/decoder 1518 may comprise an autoencoder model that comprises a CNN-based encoder and a CNN-based decoder. The CNN-based encoder comprises a series of convolutional layers that generate an encoded feature tensor based on initial GPV feature tensor 1516. The dimensionality of the encoded feature tensor may be less than the dimensionality of initial GPV feature tensor 1516. The CNN-based decoder comprises a series of convolutional layers that generate GPV feature tensor 1520. GPV feature tensor 1520 may have the same dimensionality as initial GPV feature tensor 1516. GPV encoder/decoder 1518 may be implemented in a manner similar to BEV encoder/decoder 1510 but with the difference that the axes do not represent the flat surface around the vehicle but instead represent a GPV cylinder surface. In some examples, a boundary condition is that the yaw axis dimensions must remain the same between to the BEV grid and the GPV cylinder surface, so allow for the concatenations of the two tensors.

Fusion system 214 may concatenate BEV feature tensor 1512 and GPV feature tensor 1520 to generate a concatenated feature tensor 1522. As shown in the example of FIG. 15, fusion system 214 may concatenate BEV feature tensor 1512 and GPV feature tensor 1520 such that features in BEV feature tensor 1512 and GPV feature tensor 1520 with common yaw angles are in the same column (or row) of concatenated feature tensor 1522.

Furthermore, fusion system 214 may apply one or more ML models 1524 to concatenated feature tensor 1522 to generate one or more sets of output data. In some examples, the output data may represent results of one or more perception tasks. In some examples, fusion system 214 may apply a neural network model with multiple heads in order to generate sets of output data usable for various downstream applications for one or more perception tasks, such as object detection (OD), detection of vulnerable road users (VRU), road boundary detection, passenger cars, trucks, motorcycles, cyclists, busses, pedestrians, children, visual landmarks, tunnels, poles, bridges, overhead structures, traffic lights, traffic signs, road curvature, and lane markings.

and so on. In some examples, the neural network model comprises a commonly shared encoder branch and different decoder branches that generate different sets of output data.

In this way, for each sensor of the plurality of sensors, fusion system 214 may generate first encoded data for the sensor based on the sensor data from the sensor (e.g., by applying a first encoder to first encoder input data for the sensor to generate the first encoded data for the sensor, wherein the first encoder input data is based on the sensor data from the sensor), project the first encoded data for the sensor into an initial BEV feature tensor, and generate the BEV feature tensor based on the initial BEV feature tensor. Furthermore, for each sensor of the plurality of sensors, fusion system 214 may generate second encoded data for the sensor based on the sensor data from the sensor (e.g., by applying a second encoder to second encoder input data for the sensor to generate the second encoded data for the sensor, wherein the second encoder input data is based on the sensor data from the sensor), project the second encoded data for the sensor into an initial GPV feature tensor, and generate the GPV feature tensor based on the initial GPV feature tensor. In the example of FIG. 15, after projecting the first encoded data for each of the sensors into the initial BEV feature tensor, fusion system 214 may apply a first encoder-decoder model to the initial BEV feature tensor to generate the BEV feature tensor. After projecting the second encoded data for each of the sensors into the initial GPV feature tensor, fusion system 214 may apply a second encoder-decoder model to the initial GPV feature tensor to generate the GPV feature tensor.

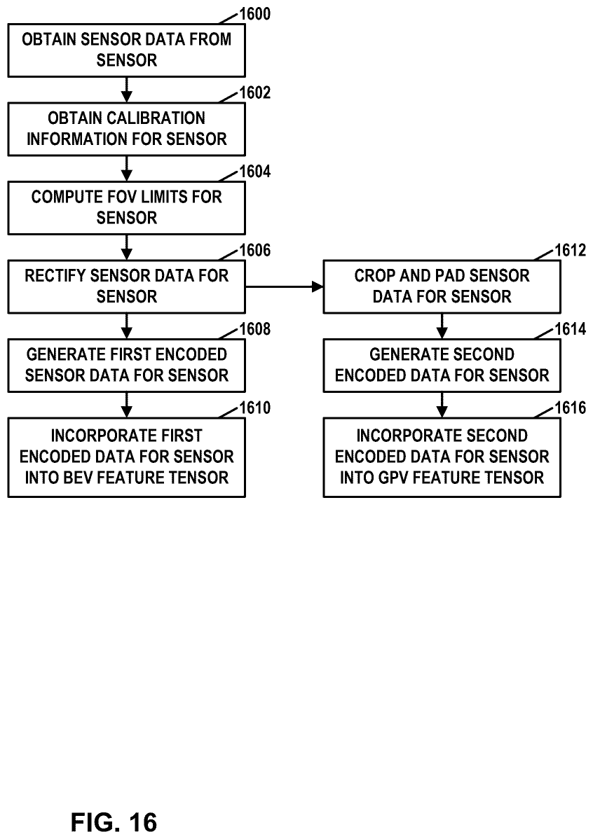

FIG. 16 is a flowchart illustrating an example operation of fusion system 214 for generating an initial BEV feature tensor 1508 and an initial GPV feature tensor 1516, in accordance with one or more techniques of this disclosure. Fusion system 214 may perform the operation of FIG. 16 for each sensor of a plurality of sensors.

In the example of FIG. 16, fusion system 214 may obtain sensor data from a sensor (1600). Additionally, fusion system 214 may obtain calibration information for the sensor (1602). For example, fusion system 214 may obtain information indicating positions, viewing angles, and other information about the sensors. Fusion system 214 may then compute field of view limits (e.g., α_{L/R,i} and φ_{U/L,i}) for the sensor based on the calibration information for the sensor (1604). In other words, fusion system 214 may determine which yaw angles and pitch angles in a BEV grid and GPV grid are visible by the sensor.

Furthermore, fusion system 214 may the rectify the sensor data (1606). Rectifying the sensor data transforms the sensor data into straight columns compatible with GPV columns. Fusion system 214 may rectify the sensor data by applying an equirectangular projection to the sensor data.

Subsequently, fusion system 214 may apply a sensor encoder (e.g., one of sensor encoders 1504) to the rectified sensor data to generate a first set of encoded sensor data for the sensor (1608). Fusion system 214 may then apply a BEV transform 1506 to the first set of encoded sensor data for the sensor to incorporate the first set of encoded sensor data for the sensor into an initial BEV feature tensor 1508 (1610). In some examples, the encoded sensor data includes feature vectors and distance vectors corresponding to rays originating from different sensors. In some examples, the encoded sensor data generated by each of sensor encoders 1504 includes feature vectors and distance vectors. The feature vectors correspond to different rays in a set of rays originating from the sensor corresponding to the sensor encoder. The distance vectors correspond to different rays in the set of rays. Each of the rays may represent a different combination of a yaw angle and a vertical pitch angle. Each of the feature vectors may indicate what kinds of objects (cars, pedestrians etc.) exist along the ray corresponding to the feature vector but does not the distances of the objects. Each of the distance vectors may have intensity spikes indicating locations along the ray corresponding to the distance vector where objects are located but the distance vector does not describe the types of the objects. For example, a feature vector corresponding to a ray may indicate that there is a pedestrian and a cyclist along the ray and a distance vector corresponding to the ray may indicate that objects are located 15 meters and 25 meters along the ray. However, the feature vector and the distance vector do not necessarily specify that the pedestrian is at 15 meters or the cyclist is at 25 meters along the ray.

BEV transform 1506 may use global context information to map information from the feature vectors for different sensors to cells of initial BEV feature tensor 1508. The global context information may be used to determine spatial relationships between objects in different views. In some examples, BEV transform 1506 may use a BAEFormer (Bi-directional and Early Interaction Transformers) framework as described in Pan et al., “BAEFormer: Bi-directional and Early Interaction Transformers for Bird's Eye View Semantic Segmentation,” available at https://openaccess.thecvf.com/content/CVPR2023/papers/Pan_BAEFormer_Bi-Directional_and_Early_Interaction_Transformers_for_Birds_Eye_View_CVPR_2023_paper.pdf. The BAEFormer approach employs bi-directional cross-attention mechanisms to effectively aggregate multi-scale image features into a better BEV representation. In another example, BEV transform 1506 may use a BEVFormer framework, as described in Li et al., “BEVFormer: Learning Bird's-Eye-View Representation from Multi-Camera Images via Spatiotemporal Transformers,” arXiv:2203.17270v2 [cs.CV] 13 Jul. 2022. BEVFormer uses spatiotemporal transformers to learn unified BEV representations from multi-camera images. BEVFormer integrates both spatial and temporal information through predefined grid-shaped BEV queries. Each BEV query extracts spatial features from regions of interest across camera views, enhancing spatial information aggregation.

Rows of initial BEV feature tensor 1508 corresponds to yaw angles radiating from an origin point of the BEV surface. Columns of initial BEV feature tensor 1508 may correspond to radial distances from the origin point of the BEV surface. For each feature of each feature vector, BEV transform 1506 may project information (e.g., object types) indicated by the feature vector into a cell in a row corresponding to the yaw angle of the feature vector and a column corresponding to a distance indicated by the distance vector. Since the rays may have different pitch angles, a result of this projection is z-collapse. That is, information from multiple feature vectors may be projected into the same cell of a row of the initial BEV feature tensor 1508.

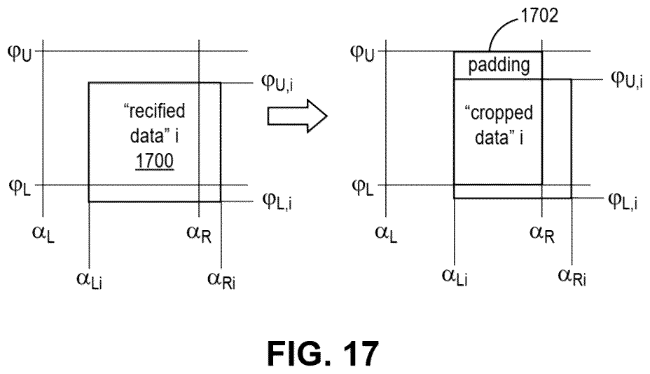

In addition, fusion system 214 may crop and/or pad the rectified sensor data for the sensor (1612). Cropping and padding the rectified sensor data is described with greater detail with reference to FIG. 17. Fusion system 214 may apply a sensor encoder (e.g., one of sensor encoders 1504) to the rectified, cropped, and padded sensor data for the sensor to generate a second set of encoded sensor data for the sensor (1614). Fusion system 214 may then apply a GPV transform 1514 to the second set of encoded sensor data for the sensor to incorporate the second set of encoded sensor data for the sensor into an initial GPV feature tensor 1516 (1616). In some examples, the encoded sensor data includes feature vectors and distance vectors. GPV transform 1514 may project the feature vectors and the distance vectors onto the GPV surface to generate the GPV feature tensor. For example, GPV transform 1514 may ignore all features in the feature vectors corresponding to objects less than a threshold distance from an origin point of the GPV surface. Initial GPV feature tensor 1516 may include rows corresponding to yaw angles and columns corresponding to pitch angles. For each of the feature vectors, GPV transform 1514 may map the remaining object types indicated in the feature vector to a cell of initial GPV feature tensor 1516. The cell may be calculated based on a spatial position of a sensor corresponding to the feature vector and an origin point of the GPV surface. In some examples, the cell may correspond to a point where the ray corresponding to the feature vector intersects the GPV surface, ignoring discrepancies in positions of sensors. Thus, in such examples, initial GPV feature tensor 1516 may provide a complete matrix of object types and distances based on multiple sensors. In some examples, cells of initial GPV feature tensor 1516 may indicate that cells have information from multiple sensors.

FIG. 17 is a conceptual diagram illustrating an example of cropping and padding sensor data, in accordance with one or more techniques of this disclosure. As noted above, fusion system 214 may compute field of view limits (e.g., α_{L/R,i} and φ_{U/L,i}) for a sensor based on the calibration for the sensor. The field of view limits for the sensor may not correspond to predefined limits of the GPV grid. Thus, if a field of view limit for the sensor extends beyond a limit of the GPV grid, fusion system 214 may crop the portion of the rectified sensor data that extends beyond the limit of the GPV grid. If the field of view limits for the sensor do not extend as far as a limit of the GPV grid, fusion system 214 may pad the rectified sensor data so that the rectified sensor data extends to the limit of the GPV grid.

In the example of FIG. 17, the values α_{L,i} and α_{R,i} indicate left and right azimuth/yaw limits of the rectified sensor data 1700. φ_{U,i}, and φ_{L,i} indicate upper and lower limits of the rectified sensor data 1700. The values α_{L} and α_{R} indicate left and right azimuth/yaw limits of the GPV grid. φ_{U}, and φ_{L} indicate upper and lower limits of the GPV grid. In some examples, such as examples where objects at distances less than and greater than the threshold distance are projected onto the GPV grid, fusion system 214 may crop the portion of rectified sensor data 1700 that is lower than the lower limit of the GPV grid and right of the right limit of the GPV grid. That is, since the lower limit of rectified sensor data 1700 is lower than the lower limit of the GPV grid and the right limit of rectified sensor data 1700 is right of the right limit of the GPV grid, fusion system 214 may crop the portion of rectified sensor data 1700 that is lower than the lower limit of the GPV grid and right of the right limit of the GPV grid. Since the upper limit of rectified sensor data 1700 does not extend as far as an upper limit of the GPV grid, fusion system 214 may generate padding 1702 to pad out rectified sensor data 1700 to the upper limit of the GPV grid. In some examples, such as examples where only objects at distances equal to or greater than the threshold distance are projected onto the GPV grid, GPV transform 1516 may perform the cropping and padding as part of the transformation process.

In this way, fusion system 214 may rectify the sensor data from the sensor to generate rectified sensor data for the sensor. Fusion system 214 may resize (e.g., crop and/or pad) the rectified sensor data for the sensor to generate resized sensor data for the sensor. Encoder input data for the sensor may comprise the rectified sensor data or the resized sensor data for the sensor.

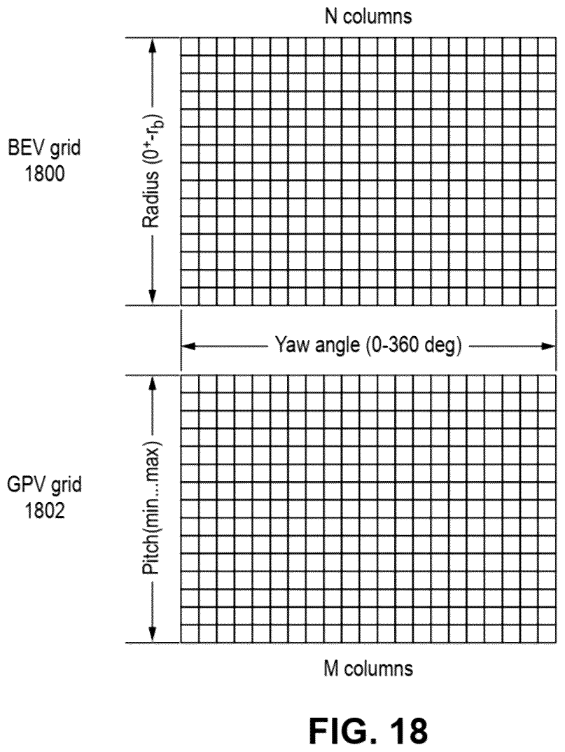

FIG. 18 is a conceptual diagram illustrating an example fusion space compute representation, in accordance with one or more techniques of this disclosure. In the example of FIG. 18, a BEV grid 1800 has N columns and a GPV grid 1802 has M columns. The columns of BEV grid 1800 and GPV grid 1802 correspond to yaw angles. In some examples, N may be equal to M. In other examples, N is an integer multiple of M (e.g., N=2*M). In other examples, M is an integer multiple of N (e.g., M=3*N). Having N be equal to M, N being an integer multiple of M, or M being an integer multiple of N may avoid moiré effects between BEV grid 1800 and GPV grid 1802.

The rows of BEV grid 1800 correspond to different radial positions that range from 0 to the maximum radius (re). The rows of GPV grid correspond to pitch angles, ranging from a minimum pitch angle to a maximum pitch angle. Each cell in BEV grid 1800 may contain encoded data representing information at and above (z>0) the location corresponding to the cell. In some examples, cells in the GPV grid may contain encoded data representing information regarding objects at the location corresponding to the cell and information regarding objects at locations beyond the location corresponding to the cell in the radial direction (r>r_{b}). In some examples, cells in the GPV grid may contain encoded data representing information regarding objects at the location corresponding to the cell, information regarding objects at locations beyond the location corresponding to the cell in the radial direction (r>r_{b}), and information regarding objects at locations closer to the origin than the location corresponding to the cell in the radial direction (r<r_{b}).

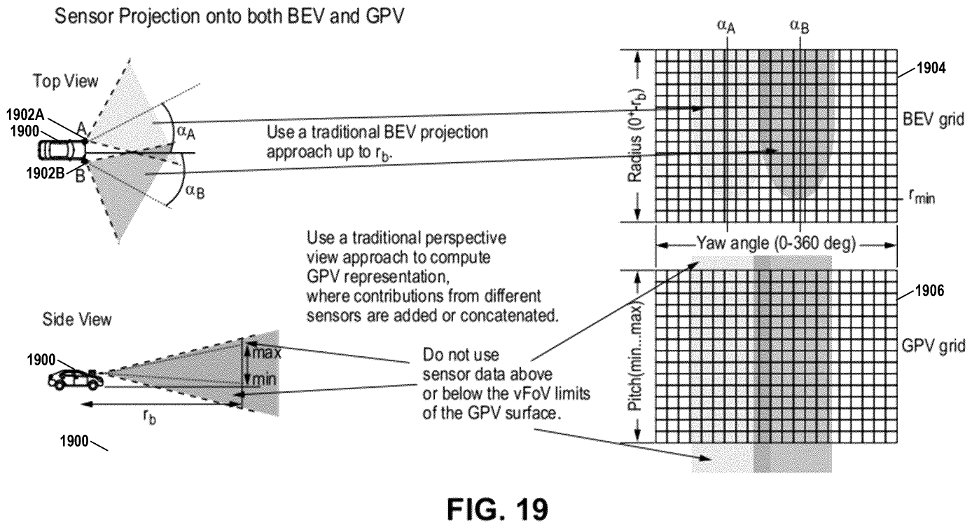

FIG. 19 is a conceptual diagram illustrating examples of sensor projection, in accordance with one or more techniques of this disclosure. As shown in FIG. 19, a vehicle 1900 includes sensors 1902A, 1902B (collectively, “sensors 1902”). The fields of view of sensors 1902 projected onto a BEV surface are shown in a graph 1904 of a BEV grid. As shown with respect to a side view of vehicle 1900, the fields of view of sensors 1902 projected onto a GPV surface are shown in a graph 1906 of a GPV grid.

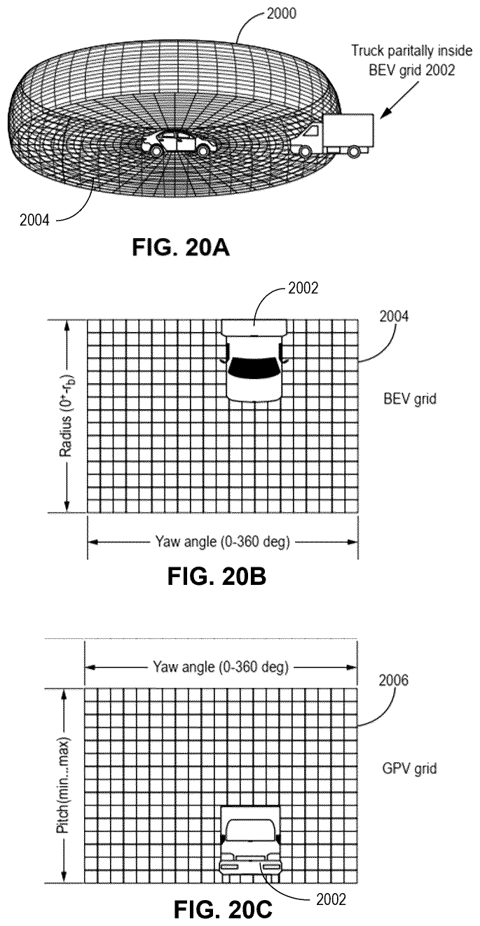

FIG. 20A is a conceptual diagram illustrating an example feature fusion grid 2000 with a truck 2002 partially within a BEV grid 2004. FIG. 20B and FIG. 20C are conceptual diagrams showing the truck 2002 in a BEV grid 2004 and a GPV grid 2006, respectively. BEV grid 2004 provides a top view, allowing for accurate radial (r<r_{b}) and yaw positioning. GPV grid 2006 provides a front view, allowing for classification, yaw and pitch positioning, for positions r>r_{b}. As show in FIG. 20B, there may be ghosting elements associated with truck 2002, but at distances greater than re the ghosting elements are not excessively separated. FIG. 20A and FIG. 20B illustrate how the two fusion grids may provide different views of the same situation without having the drawbacks of either. The BEV representation fuses the information in a way that allows for good radial estimates, while the GPV allows representation of pitch and objects beyond the re limit of the BEV.

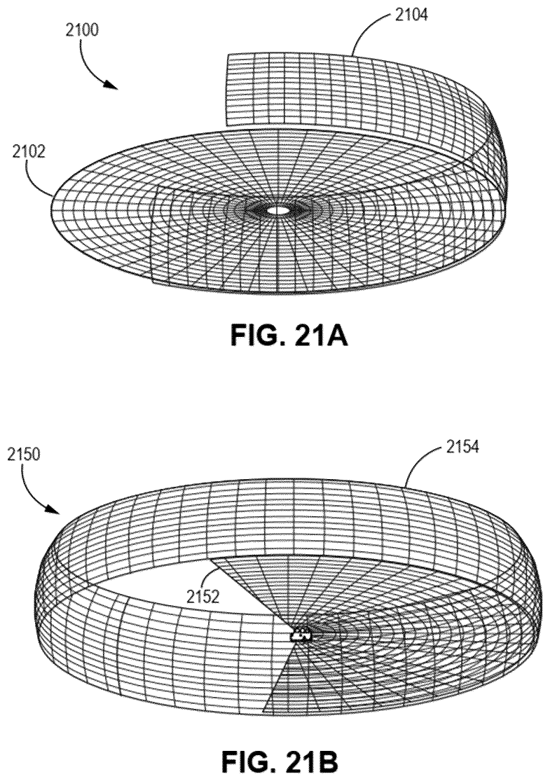

FIG. 21A is a conceptual diagram illustrating an example fusion surface 2100 with a BEV surface 2102 and a partial GPV surface 2104, in accordance with one or more techniques of this disclosure. Partial GPV surface 2104 does not extend through an entire 360° azimuth range. In other words, the GPV surface encompasses an azimuthal range less than 360°. FIG. 21B is a conceptual diagram illustrating an example fusion surface 2150 with a partial BEV surface 2152 and a complete GPV surface 2154, in accordance with one or more techniques of this disclosure. Partial BEV surface 2152 does not extend through an entire 360° azimuth range. In other words, the BEV surface encompasses an azimuthal range less than 360°. A fusion surface, such fusion surface 2100 and fusion surface 2150, with partial BEV surfaces or GPV surfaces may be used with the techniques of this disclosure to reduce computational load.

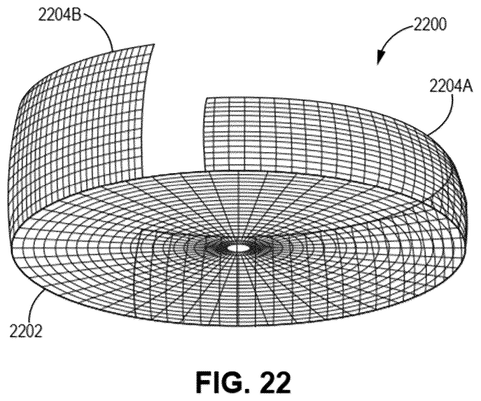

FIG. 22 is a conceptual diagram illustrating an example fusion surface 2200 with a BEV surface 2202 and multiple GPV surface sections 2204A, 2204B, in accordance with one or more techniques of this disclosure. GPV surface sections 2204A, 2204B may be discontinuous from one another. In other examples, GPV surface sections 2204A, 2204B may be continuous with one another or overlap with one another. In some examples, GPV surface sections 2204A, 2204B may have different pitch ranges. For instance, GPV surface section 2204A has a lower upper pitch limit than GPV surface section 2204B. Thus, in the example of FIG. 22, a GPV surface may comprise a first GPV surface section and a second GPV surface section, the first GPV surface section encompasses an azimuthal range less than 360°, and a second GPV surface section encompasses an azimuthal range not encompassed by the first GPV surface section.

Various examples of the techniques of this disclosure are summarized in the following clauses:

Clause 1. A method for performing a perception task, the method comprising: obtaining sensor data from a plurality of sensors, wherein the sensor data includes representations of objects detected by the sensors, the objects comprising one or more first detected objects that are at distances less than a designated distance and one or more second detected objects that are at distances greater than the designated distance; generating a Bird's Eye View (BEV) feature tensor that represents the one or more first detected objects projected onto a BEV surface; generating a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned; concatenating the BEV feature tensor and the GPV feature tensor along the sector lines of the BEV grid and the column lines of the GPV grid to generate a concatenated tensor; and performing a perception task based on the concatenated tensor.

Clause 2. The method of clause 1, further comprising determining the designated distance based on a computational cost of the BEV grid and a computational cost of the GPV grid.

Clause 3. The method of clause 1, wherein: for each sensor of the plurality of sensors, the sensor data includes sensor data from the sensor, generating the BEV feature tensor comprises, for each sensor of the plurality of sensors: generating first encoded data for the sensor based on the sensor data from the sensor; projecting the first encoded data for the sensor into an initial BEV feature tensor; generating the BEV feature tensor based on the initial BEV feature tensor; and generating the GPV feature tensor comprises, for each sensor of the plurality of sensors: generating second encoded data for the sensor based on the sensor data from the sensor; projecting the second encoded data for the sensor into an initial GPV feature tensor; and generating the GPV feature tensor based on the initial GPV feature tensor.

Clause 4. The method of clause 3, wherein: generating the BEV feature tensor comprises, after projecting the first encoded data for each of the sensors into the initial BEV feature tensor, applying a first encoder-decoder model to the initial BEV feature tensor to generate the BEV feature tensor, and generating the GPV feature tensor comprises, after projecting the second encoded data for each of the sensors into the initial GPV feature tensor, applying a second encoder-decoder model to the initial GPV feature tensor to generate the GPV feature tensor.

Clause 5. The method of clause 3, wherein: generating the first encoded data for the sensor comprises applying a first encoder to first encoder input data for the sensor to generate the first encoded data for the sensor, wherein the first encoder input data is based on the sensor data from the sensor; and generating the second encoded data for the sensor comprises applying a second encoder to second encoder input data for the sensor to generate the second encoded data for the sensor, wherein the second encoder input data is based on the sensor data from the sensor.

Clause 6. The method of clause 5, for at least one sensor of the plurality of sensors, the method further comprises: rectifying the sensor data from the sensor to generate rectified sensor data for the sensor; and resizing the rectified sensor data for the sensor to generate resized sensor data for the sensor, wherein the first encoder input data for the sensor comprises the rectified sensor data and the second encoder input data for the sensor comprises the resized sensor data for the sensor.

Clause 7. The method of clause 1, wherein the GPV surface comprises a first GPV surface section and a second GPV surface section, the first GPV surface section encompasses an azimuthal range less than 360°, and a second GPV surface section encompasses an azimuthal range not encompassed by the first GPV surface section.

Clause 8. The method of clause 1, further comprising controlling a vehicle or robot based results of the perception task.

Clause 9. A device comprising: one or more memories configured to store sensor data obtained from a plurality of sensors, wherein the sensor data includes representations of objects detected by the sensors, the objects comprising one or more first detected objects that are at distances less than a designated distance and one or more second detected objects that are at distances greater than the designated distance; one or more processors configured to: generate a Bird's Eye View (BEV) feature tensor that represents the one or more first detected objects projected onto a BEV surface; generate a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned; concatenate the BEV feature tensor and the GPV feature tensor along the sector lines of the BEV grid and the column lines of the GPV grid to generate a concatenated tensor; and perform a perception task based on the concatenated tensor.

Clause 10. The device of clause 9, wherein the one or more processors are configured to determine the designated distance based on a computational cost of the BEV grid and a computational cost of the GPV grid.

Clause 11. The device of clause 9, wherein: for each sensor of the plurality of sensors, the sensor data includes sensor data from the sensor, the one or more processors are configured to, as part of generating the BEV feature tensor, for each sensor of the plurality of sensors: generate first encoded data for the sensor based on the sensor data from the sensor; project the first encoded data for the sensor into an initial BEV feature tensor; generate the BEV feature tensor based on the initial BEV feature tensor; and the one or more processors are configured to, as part of generating the GPV feature tensor, for each sensor of the plurality of sensors: generate second encoded data for the sensor based on the sensor data from the sensor; project the second encoded data for the sensor into an initial GPV feature tensor; and generate the GPV feature tensor based on the initial GPV feature tensor.

Clause 12. The device of clause 11, wherein: the one or more processors are configured to, as part of generating the BEV feature tensor, after projecting the first encoded data for each of the sensors into the initial BEV feature tensor, apply a first encoder-decoder model to the initial BEV feature tensor to generate the BEV feature tensor, and the one or more processors are configured to, as part of generating the GPV feature tensor, after projecting the second encoded data for each of the sensors into the initial GPV feature tensor, apply a second encoder-decoder model to the initial GPV feature tensor to generate the GPV feature tensor.

Clause 13. The device of clause 11, wherein: the one or more processors are configured to, as part of generating the first encoded data for the sensor, apply a first encoder to first encoder input data for the sensor to generate the first encoded data for the sensor, wherein the first encoder input data is based on the sensor data from the sensor; and the one or more processors are configured to, as part of generating the second encoded data for the sensor, apply a second encoder to second encoder input data for the sensor to generate the second encoded data for the sensor, wherein the second encoder input data is based on the sensor data from the sensor.

Clause 14. The device of clause 13, for at least one sensor of the plurality of sensors, the one or more processors are further configured to: rectify the sensor data from the sensor to generate rectified sensor data for the sensor; and resize the rectified sensor data for the sensor to generate resized sensor data for the sensor, wherein the first encoder input data for the sensor comprises the rectified sensor data and the second encoder input data for the sensor comprises the resized sensor data for the sensor.

Clause 15. The device of clause 9, wherein the one or more processors are configured to apply a neural network model to the concatenated tensor to generate output data representing results of the perception task.

Clause 16. The device of clause 15, wherein the output data representing one or more of: objects, vulnerable road users, roadway boundaries, vehicles, cyclists, pedestrians, visual landmarks, tunnels, poles, bridges, overhead structures, traffic lights, traffic signs, road curvature, or lane markings.

Clause 17. The device of clause 9, wherein the GPV surface encompasses an azimuthal range less than 360° or the BEV surface encompasses an azimuthal range less than 360°.

Clause 18. The device of clause 9, wherein the GPV surface comprises a first GPV surface section and a second GPV surface section, the first GPV surface section encompasses an azimuthal range less than 360°, and a second GPV surface section encompasses an azimuthal range not encompassed by the first GPV surface section.

Clause 19. The device of clause 9, wherein the one or more processors are configured to control a vehicle or robot based on results of the perception task.

Clause 20. One or more non-transitory computer-readable storage media having instructions stored thereon that, when executed by one or more processors, cause the one or more processors to: obtain sensor data from a plurality of sensors, wherein the sensor data includes representations of objects detected by the sensors, the objects comprising one or more first detected objects that are at distances less than a designated distance and one or more second detected objects that are at distances greater than the designated distance; generate a Bird's Eye View (BEV) feature tensor that represents the one or more first detected objects projected onto a BEV surface; generate a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned; concatenate the BEV feature tensor and the GPV feature tensor along the sector lines of the BEV grid and the column lines of the GPV grid to generate a concatenated tensor; and perform a perception task based on the concatenated tensor.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method for performing a perception task, the method comprising:
obtaining sensor data from a plurality of sensors, wherein the sensor data includes representations of objects detected by the sensors, the objects comprising one or more first detected objects that are at distances less than a designated distance and one or more second detected objects that are at distances greater than the designated distance;
generating a Bird's Eye View (BEV) feature tensor that represents the one or more first detected objects projected onto a BEV surface;
generating a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned;
concatenating the BEV feature tensor and the GPV feature tensor along the sector lines of the BEV grid and the column lines of the GPV grid to generate a concatenated tensor; and
performing a perception task based on the concatenated tensor.

2. The method of claim 1, further comprising determining the designated distance based on a computational cost of the BEV grid and a computational cost of the GPV grid.

3. The method of claim 1, wherein:
for each sensor of the plurality of sensors, the sensor data includes sensor data from the sensor,
generating the BEV feature tensor comprises, for each sensor of the plurality of sensors:
generating first encoded data for the sensor based on the sensor data from the sensor;
projecting the first encoded data for the sensor into an initial BEV feature tensor;
generating the BEV feature tensor based on the initial BEV feature tensor; and
generating the GPV feature tensor comprises, for each sensor of the plurality of sensors:
generating second encoded data for the sensor based on the sensor data from the sensor;
projecting the second encoded data for the sensor into an initial GPV feature tensor; and
generating the GPV feature tensor based on the initial GPV feature tensor.

4. The method of claim 3, wherein:
generating the BEV feature tensor comprises, after projecting the first encoded data for each of the sensors into the initial BEV feature tensor, applying a first encoder-decoder model to the initial BEV feature tensor to generate the BEV feature tensor, and
generating the GPV feature tensor comprises, after projecting the second encoded data for each of the sensors into the initial GPV feature tensor, applying a second encoder-decoder model to the initial GPV feature tensor to generate the GPV feature tensor.

5. The method of claim 3, wherein:
generating the first encoded data for the sensor comprises applying a first encoder to first encoder input data for the sensor to generate the first encoded data for the sensor, wherein the first encoder input data is based on the sensor data from the sensor; and
generating the second encoded data for the sensor comprises applying a second encoder to second encoder input data for the sensor to generate the second encoded data for the sensor, wherein the second encoder input data is based on the sensor data from the sensor.

6. The method of claim 5, for at least one sensor of the plurality of sensors, the method further comprises:
rectifying the sensor data from the sensor to generate rectified sensor data for the sensor; and
resizing the rectified sensor data for the sensor to generate resized sensor data for the sensor,
wherein the first encoder input data for the sensor comprises the rectified sensor data and the second encoder input data for the sensor comprises the resized sensor data for the sensor.

7. The method of claim 1, wherein the GPV surface comprises a first GPV surface section and a second GPV surface section, the first GPV surface section encompasses an azimuthal range less than 360°, and a second GPV surface section encompasses an azimuthal range not encompassed by the first GPV surface section.

8. The method of claim 1, further comprising controlling a vehicle or robot based results of the perception task.

9. A device comprising:
one or more memories configured to store sensor data obtained from a plurality of sensors, wherein the sensor data includes representations of objects detected by the sensors, the objects comprising one or more first detected objects that are at distances less than a designated distance and one or more second detected objects that are at distances greater than the designated distance;
one or more processors configured to:
generate a Bird's Eye View (BEV) feature tensor that represents the one or more first detected objects projected onto a BEV surface;
generate a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned;
concatenate the BEV feature tensor and the GPV feature tensor along the sector lines of the BEV grid and the column lines of the GPV grid to generate a concatenated tensor; and
perform a perception task based on the concatenated tensor.

10. The device of claim 9, wherein the one or more processors are configured to determine the designated distance based on a computational cost of the BEV grid and a computational cost of the GPV grid.

11. The device of claim 9, wherein:
for each sensor of the plurality of sensors, the sensor data includes sensor data from the sensor,
the one or more processors are configured to, as part of generating the BEV feature tensor, for each sensor of the plurality of sensors:
generate first encoded data for the sensor based on the sensor data from the sensor;
project the first encoded data for the sensor into an initial BEV feature tensor;
generate the BEV feature tensor based on the initial BEV feature tensor; and
the one or more processors are configured to, as part of generating the GPV feature tensor, for each sensor of the plurality of sensors:
generate second encoded data for the sensor based on the sensor data from the sensor;
project the second encoded data for the sensor into an initial GPV feature tensor; and
generate the GPV feature tensor based on the initial GPV feature tensor.

12. The device of claim 11, wherein:
the one or more processors are configured to, as part of generating the BEV feature tensor, after projecting the first encoded data for each of the sensors into the initial BEV feature tensor, apply a first encoder-decoder model to the initial BEV feature tensor to generate the BEV feature tensor, and
the one or more processors are configured to, as part of generating the GPV feature tensor, after projecting the second encoded data for each of the sensors into the initial GPV feature tensor, apply a second encoder-decoder model to the initial GPV feature tensor to generate the GPV feature tensor.

13. The device of claim 11, wherein:
the one or more processors are configured to, as part of generating the first encoded data for the sensor, apply a first encoder to first encoder input data for the sensor to generate the first encoded data for the sensor, wherein the first encoder input data is based on the sensor data from the sensor; and
the one or more processors are configured to, as part of generating the second encoded data for the sensor, apply a second encoder to second encoder input data for the sensor to generate the second encoded data for the sensor, wherein the second encoder input data is based on the sensor data from the sensor.

14. The device of claim 13, for at least one sensor of the plurality of sensors, the one or more processors are further configured to:
rectify the sensor data from the sensor to generate rectified sensor data for the sensor; and
resize the rectified sensor data for the sensor to generate resized sensor data for the sensor,
wherein the first encoder input data for the sensor comprises the rectified sensor data and the second encoder input data for the sensor comprises the resized sensor data for the sensor.

15. The device of claim 9, wherein the one or more processors are configured to apply a neural network model to the concatenated tensor to generate output data representing results of the perception task.

16. The device of claim 15, wherein the output data representing one or more of: objects, vulnerable road users, roadway boundaries, vehicles, cyclists, pedestrians, visual landmarks, tunnels, poles, bridges, overhead structures, traffic lights, traffic signs, road curvature, or lane markings.

17. The device of claim 9, wherein the GPV surface encompasses an azimuthal range less than 360° or the BEV surface encompasses an azimuthal range less than 360°.

18. The device of claim 9, wherein the GPV surface comprises a first GPV surface section and a second GPV surface section, the first GPV surface section encompasses an azimuthal range less than 360°, and a second GPV surface section encompasses an azimuthal range not encompassed by the first GPV surface section.

19. The device of claim 9, wherein the one or more processors are configured to control a vehicle or robot based on results of the perception task.

20. One or more non-transitory computer-readable storage media having instructions stored thereon that, when executed by one or more processors, cause the one or more processors to:
obtain sensor data from a plurality of sensors, wherein the sensor data includes representations of objects detected by the sensors, the objects comprising one or more first detected objects that are at distances less than a designated distance and one or more second detected objects that are at distances greater than the designated distance;
generate a Bird's Eye View (BEV) feature tensor that represents the one or more first detected objects projected onto a BEV surface;
generate a Generalized Perspective View (GPV) feature tensor that represents at least the one or more second detected objects projected onto a GPV surface, wherein a BEV grid of the BEV surface and a GPV grid of the GPV surface are defined such that sector lines of the BEV grid and column lines of the GPV grid are aligned;
concatenate the BEV feature tensor and the GPV feature tensor along the sector lines of the BEV grid and the column lines of the GPV grid to generate a concatenated tensor; and
perform a perception task based on the concatenated tensor.
